(19) United States
(12) Patent Application Publication
(10) Pub. No.: US 2026/0336382 A1
(43) Pub. Date: Oct. 29, 2026

(54) ELECTRIC BEAM AXLE

(71) Applicant: American Axle & Manufacturing, Inc., Detroit, MI (US)

(72) Inventors: James Keith MEINTJES, Pontiac, MI (US); Matthew A. UMERLEY, Shelby Township, MI (US); Frederick E. ZINK, Capac, MI (US); Vikram CHOPRA, Troy, MI (US)

(21) Appl. No.: 19/110,222

(22) PCT Filed: Sep. 7, 2023
(86) PCT No.: PCT/US2023/032124

§ 371 Date: Mar. 10, 2025

Related U.S. Application Data
(60) Provisional application No. 63/404,654, filed on Sep. 8, 2022.

(51) Int. Cl. B60K 7/00; B60K 17/04

(52) U.S. Cl. CPC B60K 7/0007; B60K 17/043; B60K 2007/0038; B60K 2007/0061

(57) ABSTRACT

An electric beam axle with a center tube, which is disposed coaxially about an output axis, and a pair of drive units that each include a housing assembly, which is fixedly coupled to the center tube, a motor assembly, which is coupled to the housing assembly and has a motor output shaft that is rotatable about a motor axis, a wheel hub assembly, which is fixedly coupled to the housing assembly and has a wheel hub that is rotatable about the output axis, and a transmission. The housing assembly has a tube mount, which defines a bore into which the center tube is received, and defines a cavity. The motor output shaft extends into the cavity. The transmission drivingly connects the motor output shaft to the wheel hub to transmit rotary power between the electric motor and the wheel hub. The output axis is offset from the motor axes.

### CROSS-REFERENCE TO RELATED APPLICATIONS

This application claims the benefit of U.S. Provisional Patent Application No. 63/404,654 filed Sep. 8, 2022, the disclosure of which is incorporated by reference as if fully set forth in detail herein.

### FIELD

The present disclosure relates to an electric beam axle.

### BACKGROUND

This section provides background information related to the present disclosure which is not necessarily prior art.

International Patent Application No. PCT/US2022/019900 discloses various configurations for a relatively robust electric beam axle. While this configuration is well suited for its intended purpose, we have noted that there are situations where additional ground clearance would be desirable, for example in the region of the electric beam axle that includes a carrier housing and differential assembly. Accordingly, there is a need in the art for an improved electric beam axle.

### SUMMARY

This section provides a general summary of the disclosure, and is not a comprehensive disclosure of its full scope or all of its features.

In one form, the present disclosure provides an electric beam axle that includes a center tube and a pair of drive units. The center tube has opposite axial ends and is disposed coaxially about an output axis. Each of the drive units has a housing assembly, a motor assembly, a wheel hub assembly and a transmission. The housing assembly has a tube mount and defines a cavity. The tube mount defines a tube bore. The center tube is received in the tube bore and is fixedly coupled to the tube mount. The motor assembly has an electric motor with a motor output shaft that is rotatable about a motor axis. The motor assembly is coupled to the housing assembly. The motor output shaft extends into the cavity in the housing assembly. The wheel hub assembly is fixedly coupled to the housing assembly and has a wheel hub that is rotatable about the output axis. The transmission drivingly connects the motor output shaft to the wheel hub to transmit rotary power between the electric motor and the wheel hub. The output axis is offset from the motor axes.

In some examples, the housing assembly includes a housing member and an end cap that are joined to one another across a plane that is perpendicular to the output axis, the housing member includes a motor mount flange to which the electric motor is mounted, and the end cap has a bore into which the wheel hub assembly is mounted.

In other examples, the wheel hub assembly further includes a wheel hub mount and a stub shaft. The wheel hub mount is mounted to the housing assembly. The stub shaft rotationally couples an output gear of the transmission and the wheel hub. Optionally, the electric beam axle can further include a pair of tapered roller bearings, where each of the tapered roller bearings is mounted on an associated axial end of the output gear and supports the output gear for rotation about the output axis relative to the housing assembly. Also optionally, the wheel hub is supported for rotation about the output axis relative to the wheel hub mount on a pair of tapered roller bearings. As another option, the wheel hub includes a wheel hub flange, and the wheel hub assembly further includes an outer hub seal that is disposed along the output axis between the wheel hub flange and the tapered roller bearings. As yet another option, the wheel hub assembly includes a seal member that is disposed circumferentially between the wheel hub mount and an inside surface of the bore in the end cap. As a still further option, the stub shaft includes a first externally-splined segment, which is engaged to a first internally-splined segment on the output gear, and a second externally-splined segment that is engaged to a second internally-splined segment on the wheel hub.

In another example, the transmission includes an input gear, which is coupled to the motor output shaft for rotation therewith, and a pair of compound gears. Each of the compound gears has a first reduction gear that is meshingly engaged to the input gear. Optionally, the transmission further includes an output gear, each of the compound gears has a second reduction gear that is coupled for rotation with the first reduction gear, and each of the second reduction gears is meshingly engaged with the output gear.

In still another example, each of the electric motors has a motor housing, and each of the drive units further includes an inverter that is electrically coupled to the electric motor and is mounted to the motor housing.

In yet another example, each of the electric motors has a motor housing, and each of the drive units further includes a heat exchanger that is fluidly coupled to the electric motor and is mounted to the motor housing.

In a further example, the transmission of each of the drive units has an output gear and the electric beam axle includes a first stub shaft, a second stub shaft and a coupling. The first stub shaft is received in the center tube and is coupled for rotation with the output gear of a first one of the drive units. The second stub shaft is coupled for rotation with the output gear of a second one of the drive units and wherein the coupling is selectively operable for rotationally coupling the first and second stub shafts. Optionally, the coupling is a clutch, such as a dog clutch.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an exemplary electric beam axle constructed in accordance with the teachings of the present disclosure;

FIGS. 2 and 3 are exploded perspective views of a portion of the electric beam axle of FIG. 1 that depict a drive unit and a portion of a center tube assembly in more detail;

FIGS. 4 and 5 are perspective views of a portion of the electric beam axle of FIG. 1 illustrating a housing member of one of the drive units;

FIG. 6 is a side elevation view of the housing member;

FIG. 7 is a section view taken along the line 7-7 of FIG. 6;

FIGS. 8, 9 and 10 are perspective views of a portion of the electric beam axle of FIG. 1 illustrating an end cap of one of the drive units;

FIG. 11 is a side elevation view of the end cap;

FIG. 12 is a perspective view of a portion of the electric beam axle of FIG. 1 illustrating a motor assembly and a transmission of one of the drive units;

FIG. 13 is a section view taken along the line 13-13 of FIG. 1;

FIG. 14 is a perspective view of a portion of the electric beam axle of FIG. 1 illustrating the motor assembly, the transmission and a wheel hub assembly of one of the drive units;

FIG. 15 is a section view taken along the line 15-15 of FIG. 1;

FIG. 16 is a section view taken along the line 16 -16 of FIG. 1; and

FIG. 17 is a schematic illustration of a second exemplary electric beam axle constructed in accordance with the teachings of the present disclosure

Corresponding reference numerals indicate corresponding parts throughout the several views of the drawings.

### DETAILED DESCRIPTION

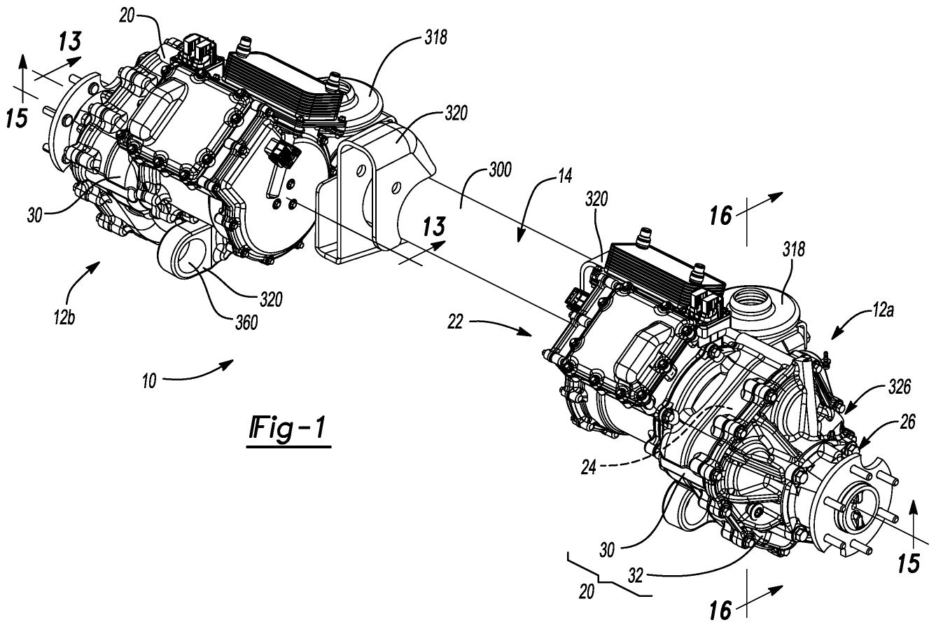

With reference to FIG. 1 of the drawings, an exemplary electric beam axle constructed in accordance with the teachings of the present disclosure is generally indicated by reference numeral 10. The electric beam axle 10 can include a pair of drive units 12a, 12b and a center tube assembly 14.

As the drive units 12a, 12b are generally similar, a discussion of the drive unit 12a will suffice for drive unit 12b. The drive unit 12a can include a housing assembly 20, a motor assembly 22, a transmission 24, and a wheel hub assembly 26.

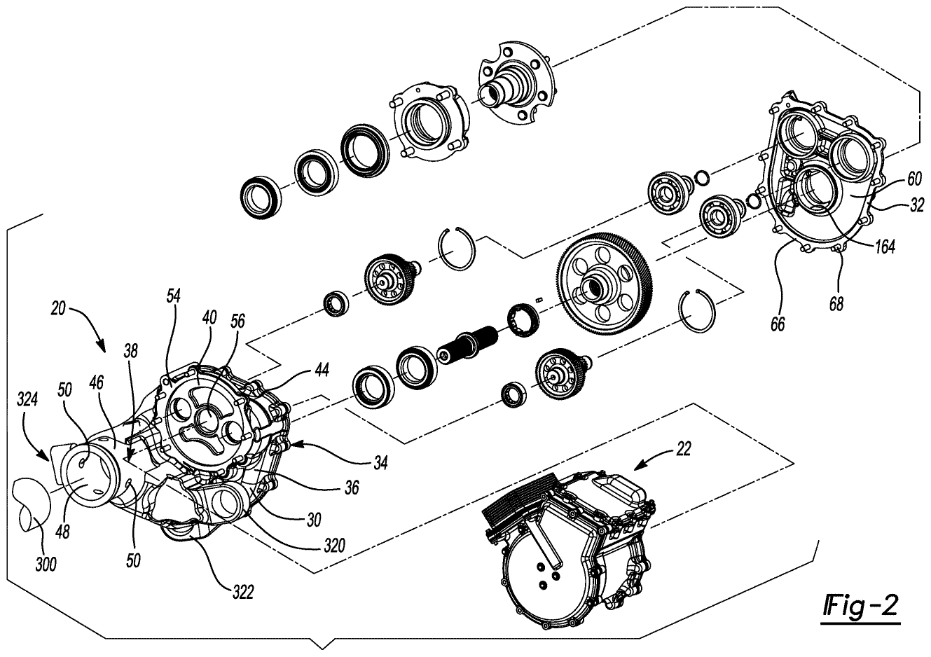

With reference to FIGS. 2 and 3, the housing assembly 20 can include a housing member 30 and an end cap 32 that can cooperate to define a cavity 34 into which the transmission 24 can be received.

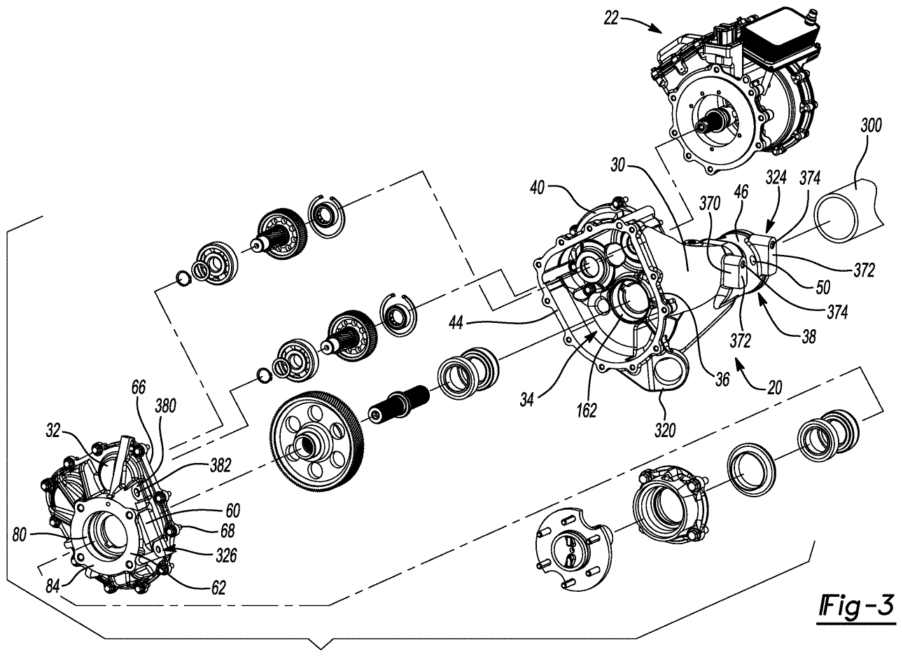

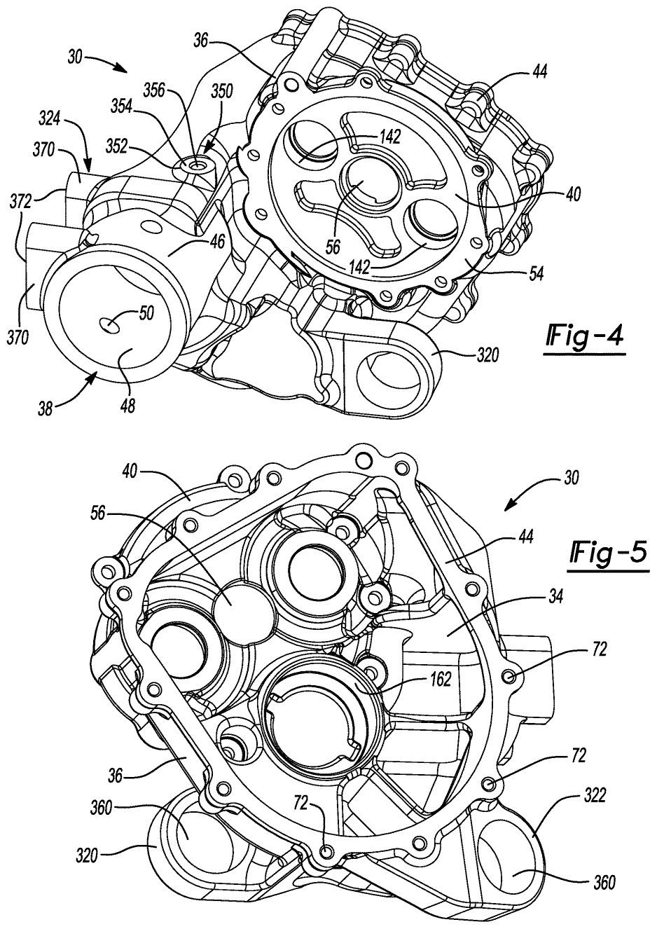

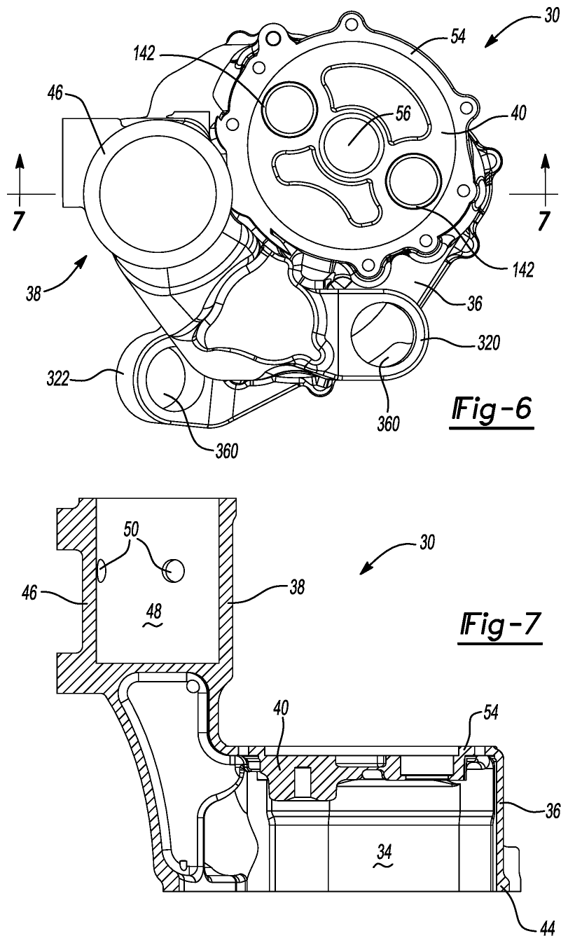

With reference to FIG. 4 through 7, the housing member 30 can define a gearbox 36, a tube mount 38, and a motor mount 40. The gearbox 36 can be open on an outboard end or side of the housing member 30 and can define a first flange member 44 that can be disposed about the portion of the cavity 34 that is defined by the housing member 30. The tube mount 38 has a tubular collar 46 that defines a tube bore 48 that is open on an inboard end of the housing member 30. Optionally, a plurality of weld slug apertures 50 can be formed radially through the tubular collar 46 and can intersect the tube bore 48. The weld slug apertures 50 can be spaced about the circumference of the tubular collar 46. The tube bore 48 can be a blind bore, or could optionally intersect a portion of the cavity 34 that is formed by the housing member 30. The motor mount 40 defines a motor mount flange 54 and a motor output shaft bore 56 that intersects the portion of the cavity 34 that is formed by the housing member 30. The motor mount flange 54 faces away from the open end of the gearbox 36.

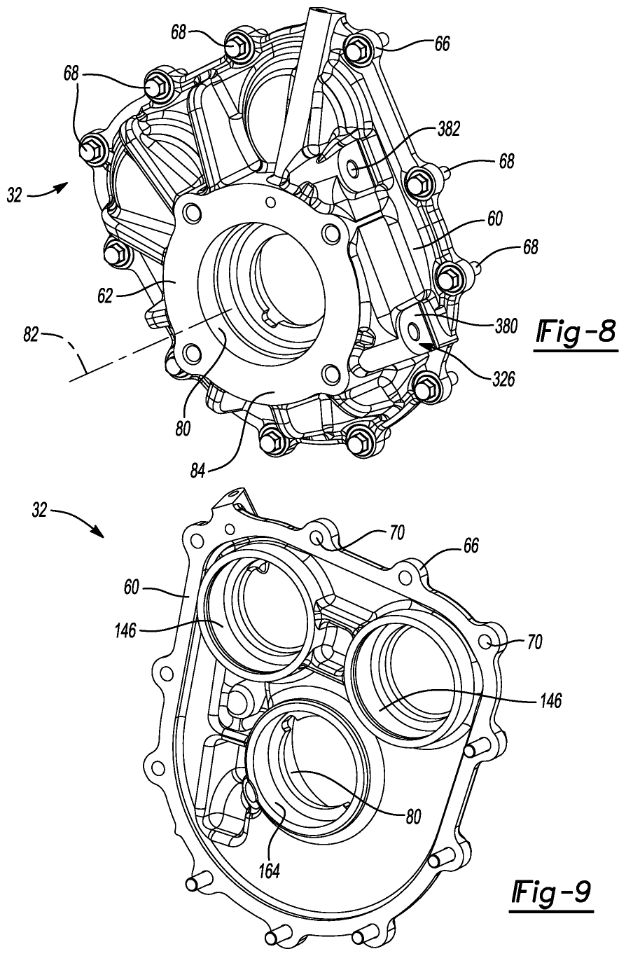

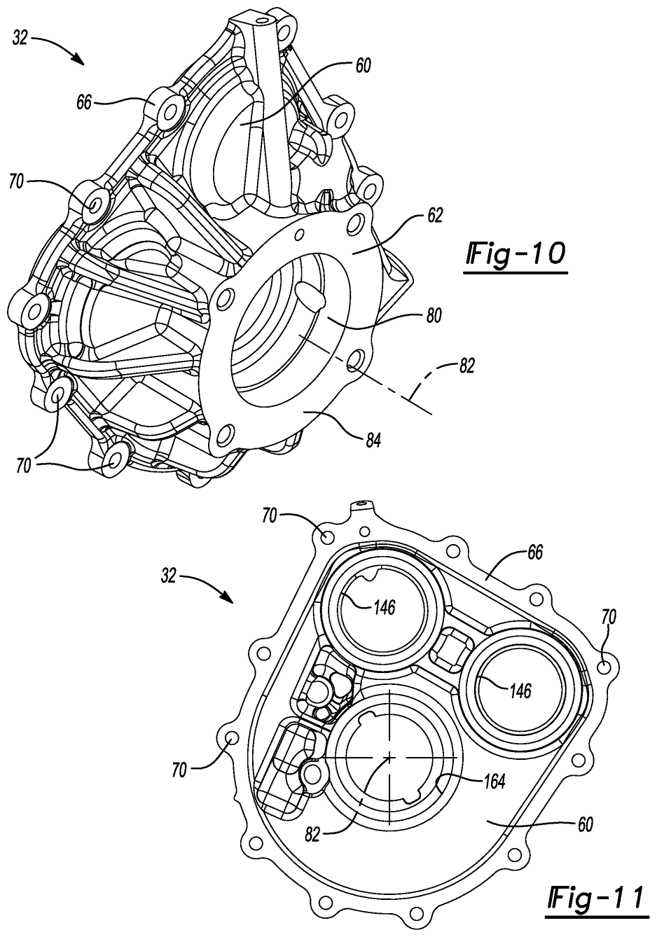

With reference to FIGS. 8 through 11, the end cap 32 can include a cover portion 60 and a wheel hub mount 62. The cover portion 60 can include a second flange member 66 that is configured to cooperate with the first flange member 44 (FIG. 5) to close the open end of the gearbox 36 (FIG. 5). In the example provided, a plurality of threaded fasteners 68 are fitted through holes 70 in the second flange member 66 and are threadably engaged to threaded holes 72 (FIG. 5) formed in the first flange member 44 (FIG. 5). The wheel hub mount 62 can define a pilot bore 80, which is disposed concentrically about an output axis 82, and a first end wall 84 that is perpendicular to the output axis 82.

Returning to FIGS. 2 and 3, a gasket or seal (not specifically shown) can be disposed between the housing member 30 and the end cap 32 in a desired location (e.g., between the first and second flange members 44 and 66) to aid in sealing the joint between the housing member 30 and the end cap 32. In the example provided, the housing member 30 and the end cap 32 are joined to one another across a plane that is perpendicular to the output axis 82.

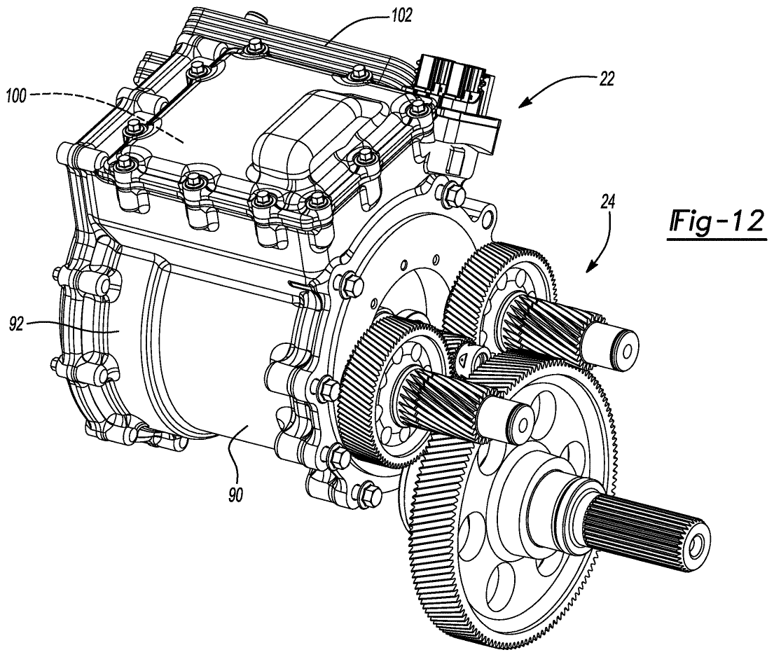

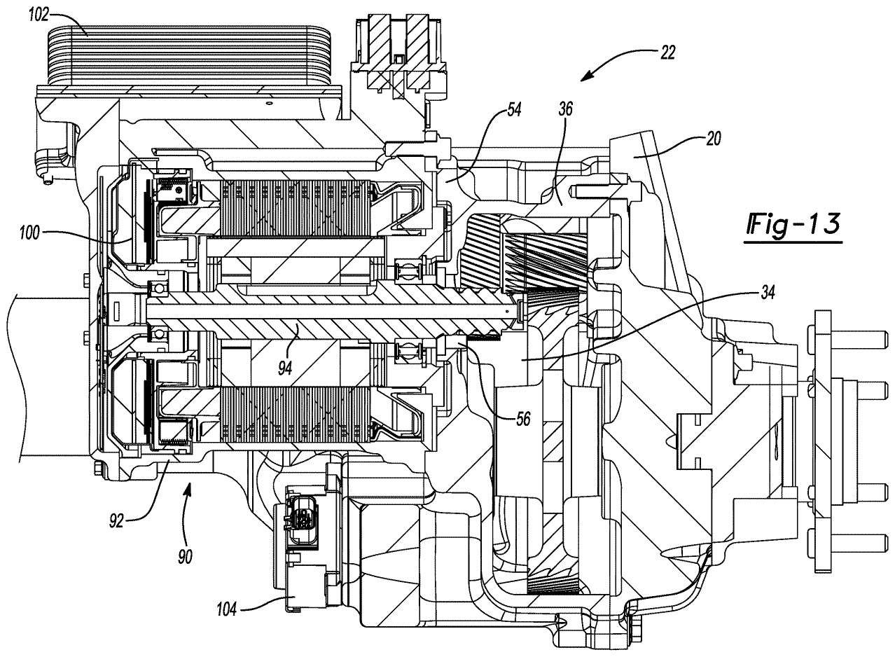

With reference to FIGS. 12 and 13, the motor assembly 22 includes an electric motor 90 having a motor housing 92 and a motor output shaft 94. The motor housing 92 is mounted to the motor mount flange 54 such that the motor output shaft 94 extends through the motor output shaft bore 56 into the portion of the cavity 34 that is formed by the gearbox 36. Optionally, the electric motor assembly 22 can include one or more of an inverter 100, a heat exchanger 102, a fluid pump 104 and a filter mount (not specifically shown). The inverter 100 is configured to control the supply of electrical power to the electric motor 90. The inverter 100 can be coupled or mounted to the motor housing 92 and can be electrically coupled to the electric motor 90. The heat exchanger 102 can be coupled or mounted to the motor housing 92 and can be employed to cool a fluid that can be circulated through the electric motor 90 and/or the transmission 24 to cool and/or lubricate the electric motor 90 and/or the transmission 24. The fluid pump 104 can be coupled to the motor housing 92 or to the housing assembly 20 and can provide a source of pressurized fluid that can be employed to cool and/or lubricate the electric motor 90 and/or the transmission 24, and optionally to cool the inverter 100. The filter mount can be coupled to the motor housing 92 and can be in fluid communication with the fluid pump 104. The filter mount can receive a fluid filter (not shown) that can be employed to filter the fluid that is circulated through the drive unit 12a by the fluid pump 104. In the example provided, various galleries (not specifically shown) that couple the fluid pump 104, the filter mount, and the electric motor 90 can be integrally formed with the motor housing 92, and/or could be formed as discrete components (i.e., tubes, hoses) that are coupled to the motor housing 92.

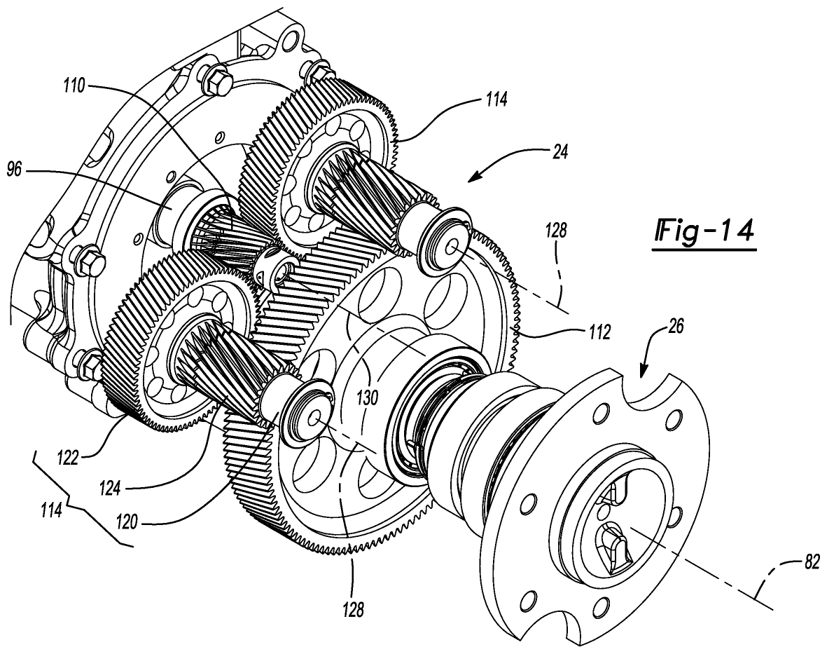

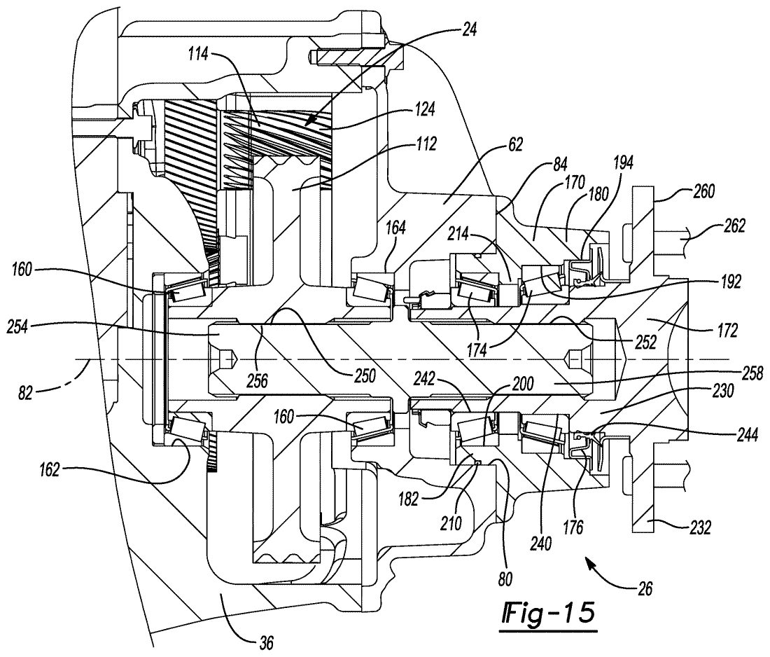

With reference to FIGS. 14 and 15, the transmission 24 can be any type of transmission for transmitting rotary power between the motor output shaft 94 and the wheel hub assembly 26. In this regard, the transmission 24 can comprise any number of reduction stages, and can be configured as a single speed transmission or a multi-speed transmission. The transmission 24 can include a drive gear 110, a driven gear 112, and gears, such as a pair of compound gears 114, that transmit rotary power between the drive gear 110 and the driven gear 112. In the particular example provided, the transmission 24 is configured in a manner that is described in commonly assigned U.S. Pat. No. 11,293,534. In brief, the drive gear 110 is the input gear of the transmission 24 and is coupled to the motor output shaft 94 for rotation therewith, and the driven gear 112 is the output gear of the transmission 24 and is rotatable about the output axis 82. Each of the compound gears 114 can have a shaft member 120, a first reduction gear 122, which is fixedly coupled to the shaft member 120 and meshingly engaged with the drive gear 110, and a second reduction gear 124 that is fixedly coupled to the shaft member 120 and meshingly engaged with the driven gear 112. Each of the shaft members 120 is rotatable about an intermediate axis 128 that is parallel to and offset from both the output axis 82 and a motor axis 130 about which the motor output shaft 94 rotates. In the example provided, the motor axes 130 are coincident and are offset from the output axis 82.

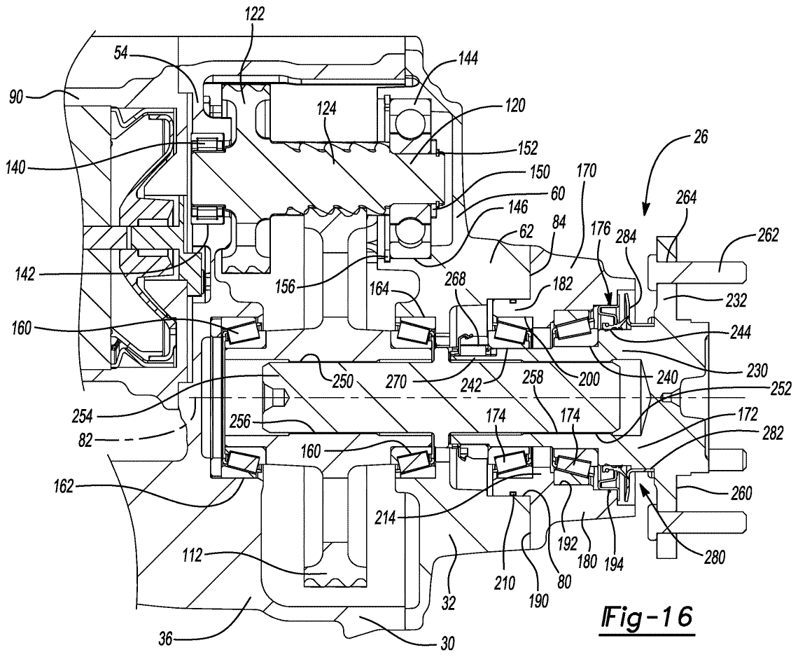

With reference to FIG. 16, each of the shaft members 120 can be supported by appropriate bearings. In the example provided, a roller bearing 140 is received into a first bearing bore 142 formed in the motor mount flange 54 and is mounted on first axial end of a corresponding one of the shaft members 120, while a ball bearing 144 is received into a second bearing bore 146 formed in the cover portion 60 of the end cap 32 and is mounted on a second, opposite axial end of the corresponding one of the shaft members 120. In the example shown, the ball bearing 144 is mounted on the second axial end of the shaft member 120 such that the inner bearing race of the ball bearing 144 is abutted against a shoulder formed on the shaft member 120, a thrust washer or spacer is received over the second axial end of the shaft member 120 and abutted against a side of the inner bearing race that is opposite the shoulder on the shaft member, and a snap ring 152 is received into a snap ring groove that is formed about the second axial end of the shaft member 120. This assembly is inserted into the second bearing bore 146 that is formed in the cover portion 60 and a retaining ring 156 is inserted into a retaining ring groove that is formed into the cover portion 60 concentric with the second bearing bore 146. The housing member 30 can be mounted to the end cap 32 to locate the first axial ends of the shaft members 120 into the first bearing bores 142. The roller bearings 140 can be mounted on first axial ends of the shaft members 120 and received into the first bearing bores 142. Thereafter the electric motor 90 can be mounted to the motor mount flange 54.

It will be appreciated that other bearing configurations could be employed in lieu of the roller bearing and ball bearing combination that is illustrated in the accompanying drawings and described herein. For example, each shaft member 120 can be supported on its opposite axial ends by a tapered roller bearing (not shown).

The driven gear 112 can be supported for rotation by a pair of bearings, such as a pair of tapered roller bearings 160. A first one of the tapered roller bearings 160 can be received into a third bearing bore 162 that is formed in a wall of the gearbox 36, while a second one of the tapered roller bearings 160 can be received into a fourth bearing bore 164 that is formed in the cover portion 60 of the end cap 32. The fourth bearing bore 164 can be concentric with the pilot bore 80.

The wheel hub assembly 26 can have a wheel hub housing 170, a wheel hub 172, a pair of tapered roller bearings 174, and an outer hub seal 176. The wheel hub housing 170 can have a body portion 180 and an annular wall 182. The body portion 180 can define a second end wall 190, a first wheel bearing bore 192, and an outer hub seal bore 194. The second end wall 190 is configured to abut the first end wall 84 of the wheel hub mount 62 that is formed on the end cap 32. The first wheel bearing bore 192 can be formed by a counterbore of a first diameter, while the outer hub seal bore 194 can be formed by a counterbore of a second, larger diameter. The annular wall 182 can extend from the second end wall 190 and can define a second wheel bearing bore 200. In the example provided, the annular wall 182 is sized to be received into the pilot bore 80 in the wheel hub mount 62 of the end cap 32 in a manner that aligns the axes of the first and second wheel bearing bores 192 and 200 to the output axis 82. A gasket or seal can be employed to seal the joint between the end cap 32 and the wheel hub housing 170. The gasket or seal could be employed between the first and second end walls 84 and 190. In the example provided, a suitable seal member 210, such as an O-ring, is received into a seal groove that is formed about the circumference of the annular wall 182 and sealingly engages both the annular wall 182 and the inside surface of the pilot bore 80 in the wheel hub mount 62 of the end cap 32. An annular shoulder 214 is formed on the wheel hub housing 170 that separates the first and second wheel bearing bores 192 and 200 from one another along the output axis 82.

The wheel hub 172 can comprise a hub member 230, and a wheel hub flange 232. The hub member 230 is a shaft having formed thereon first and second bearing mount surfaces 240 and 242, and an outer hub seal surface 244. The hub member 230 is configured to be drivingly engaged to the driven gear 112 and as such, could be configured to directly couple to the driven gear 112. For example, the driven gear 112 could include an internally-splined aperture and the hub member 230 could include an externally-splined segment (not shown) that is matingly received by the internally-splined aperture to couple the hub member 230 to the driven gear 112 for common rotation. In the example provided, however, internally-splined apertures 250 and 252 are formed in both the driven gear 112 and the hub member 230, respectively, and the wheel hub assembly 26 includes a stub shaft 254 having externally-splined segments 256 and 258 that are engaged to the internally-splined apertures 250 and 252, respectively, to rotatably couple the hub member 230 of the wheel hub 172 to the driven gear 112 such that the wheel hub 172 is rotatable about the output axis 82. The wheel hub flange 232 can be fixedly coupled to (e.g., unitarily and integrally formed with) the hub member 230 and can extend radially outwardly from the hub member 230. The wheel hub flange 232 can define a wheel mounting surface 260 that is configured to abut an inboard side of a wheel (not shown). In the example shown, a plurality of studs 262 are fitted through stud holes 264 in the wheel hub flange 232 and are fixedly coupled to the wheel hub flange 232. Lug nuts (not shown) can be threadably engaged to the studs 262 to secure the wheel to the wheel hub flange 232. Alternatively, the studs 262 may be omitted and threaded apertures (not shown) can be substituted for the stud holes 264. In this alternate configuration, wheel hub bolts (not shown) can be threaded into the threaded apertures to secure the wheel to the wheel hub flange 232. Each of the tapered roller bearings 174 is disposed on a corresponding one of the first and second bearing mount surfaces 240 and 242 and is received into a corresponding one of the first and second wheel bearing bores 192 and 299, respectively, to rotationally and axially support the hub member 230 relative to the wheel hub housing 170. The tapered roller bearings 174 can be preloaded if desired, using any desired technique. In the example provided, a nut 268 is threaded onto a threaded segment 270 on the hub member 230 and is tightened against the inner bearing race of the tapered roller bearing 174 that is disposed in the annular wall 182.

The outer hub seal 176 can be received into the outer hub seal bore 194 and fixedly and sealingly coupled to the body portion 180 of the wheel hub housing 170. The outer hub seal 176 can be disposed in any desired location, but is disposed along the output axis 82 between the wheel hub flange 232 and the tapered roller bearings 174 in the example provided. The outer hub seal 176 can be sealingly engaged to the outer hub seal surface 244 on the hub member 230. In the example shown, the outer hub seal 176 includes a lip member that contacts and sealingly engages the outer hub seal surface 244. Optionally, the wheel hub 172 can include a slinger 280 that is disposed on an outboard side of the outer hub seal 176 to protect the outer hub seal 176 from dirt and debris. The slinger 280 can have a tubular slinger hub 282, which is received on and fixedly coupled to the hub member 230, and a slinger flange 284 that extends radially outwardly from the slinger hub 282. The slinger flange 284 can contact an annular dust lip on the outer hub seal 176. Alternately, the slinger flange 284 can be spaced axially apart from the outer hub seal 176.

Returning to FIGS. 1 and 2, the center tube assembly 14 includes a center tube 300 that is received into and spans between and fixedly couples the housing assemblies 20 of the drive units 12a, 12b. In this regard, each of the opposite axial ends of the center tube 300 is received into the tube bore 48 in a corresponding one of the tube mounts 38 and is fixedly coupled to an associated one of the housing members 30 such that the center tube 300 is disposed coaxially about the output axis 82. In the example provided, the center tube 300 is press-fit into each of the tube bores 48 and slug welds (not specifically shown) are formed in each of the weld slug apertures 50 (i.e., by welding a weld slug (not shown) to the center tube 300) to inhibit axial and rotational movement of the center tube 300 relative to the tubular collars 46.

With reference to FIGS. 1 through 3, the center tube assembly 14 can include various other components that may be needed to couple the electric beam axle 10 to the suspension (not shown) of a vehicle. In the example shown, a pair of brackets 320 are fixedly coupled (e.g., welded) to the center tube 300 and are employed to mount the ends of respective upper control arms (not shown) to the electric beam axle 10. It will be appreciated that mounts for various other vehicle suspension and brake system components could be integrated into to electric drive axle 10. For example, leaf spring mounts (not shown) could be fixedly coupled to (e.g., welded to or integrally formed with) the center tube 300. In the example provided, the electric beam axle 10 includes a pair of spring seats 318, a pair of upper link mounts 320, a pair of lower link mounts 322, a pair of shock mounts 324, and a pair of caliper mounts 326.

With reference to FIGS. 1 and 4, each of the spring seats 318 can be fixedly coupled to the center tube 300 or an associated one of the housing assemblies 20 in a desired manner. In the example shown, the spring seat 318 is a discrete component that is mounted to a seat mount 350 that is unitarily and integrally formed with the housing member 30. The spring seat mount 350 has a mounting boss 352 that defines a mounting face 354 against which the spring seat 318 abuts. A threaded fastener (not shown) can extend through the spring seat 318 and can threadably engage a threaded aperture 356 formed in the mounting boss 352. It will be appreciated, however, that the spring seat 318 itself could be unitarily and integrally formed with the housing member 30.

With reference to FIGS. 1, 5 and 6, each of the upper link mounts 320 and each of the lower link mounts 322 is illustrated as being unitarily and integrally formed with an associated one of the housing members 30, but it will be appreciated that one or both of these components could be a discrete component that is fixedly coupled to the center tube 300 or to an associated one of the housing assemblies 20. In the example provided, the upper link mounts 320 and the lower link mounts 322 are formed as projections, which extend from the housing member 30, and have an associated mounting bore 360 formed therethrough.

With reference to FIGS. 3 and 4, the shock mounts 324 can be fixedly coupled to the housing assembly 20 or the center tube 300, but in the example provided, each of the shock mounts 324 comprises a pair of shock mount bosses 370 that are unitarily and integrally formed with the housing member 30. Each of the shock mount bosses 370 includes a mounting face 372 and a threaded hole 374 that is formed through the mounting face 372.

With reference to FIGS. 3 and 8, each of the caliper mounts 326 is unitarily and integrally formed with an associated one of the end caps 32 and comprises a caliper mounting face 380 into which a pair of threaded caliper bolt holes 382 are formed.

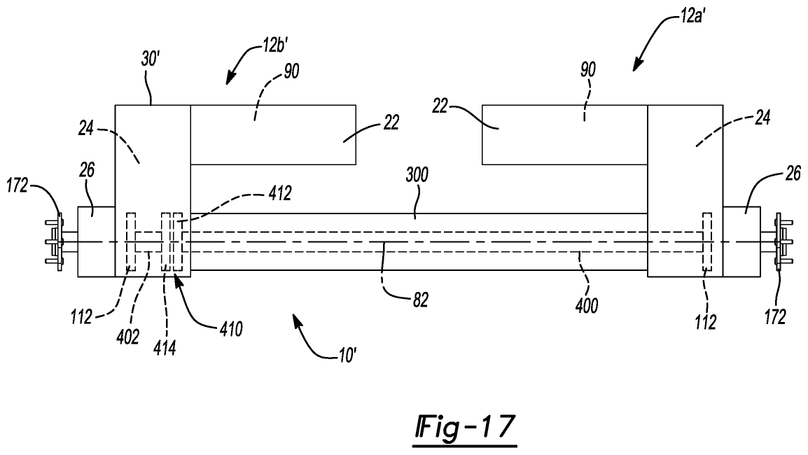

With reference to FIG. 17, a second electric beam axle 10′ is schematically illustrated. In this example, the electric beam axle 10′ is generally similar to the electric beam axle 10 of FIG. 1, except that it is configured to drivingly couple the electric motors of both drive units 12a′, 12b′ to both wheel hubs 172 on a selective basis. The center tube 300 is positioned relative to the drive units 12a′, 12b′ so that a rotational axis of a rotating element of the transmission 24 is disposed within the interior of the center tube 300. For example, the center tube 300 can be positioned relative to the drive units 12a′, 12b′ so that the rotational axis of the output of the transmission 24 (i.e., the driven gear 112 in the example shown) is disposed within the interior of the center tube 300. A first stub shaft 400 can coupled for rotation with the driven gear 112 of the drive unit 12a′ and can extend through the center tube 300 into the housing member 30′ of the drive unit 12b′. A second stub shaft 402 can be coupled for rotation with the driven gear 112 of the drive unit 12b′ and can extend toward the first stub shaft 400. Any type of coupling can be employed to selectively couple the first and second stub shafts 400 and 402 for rotation with one another. In the example provided, a dog clutch 410 is employed to selectively couple the first and second stub shafts 400 and 402 to one another. The dog clutch 410 can include a first dog member 412, which is rotationally coupled to the first stub shaft 400, and a second dog member 414 that is rotationally coupled to the second stub shaft 402. One of the first and second dog members 412 and 414 is movable along the rotational axes of the driven members 112, the first stub shaft 400 and second stub shaft 402 (i.e., the output axis 82 in the example provided) between a first position, in which the first and second dog members 412 and 414 are rotationally disengaged from one another, and a second position in which the first and second dog members 412 and 414 are coupled to one another for common rotation about the output axis 82. Any type of actuator (not shown) can be employed to cause translation for the axially movable one of the first and second dog members 412 and 414.

Configuration in this manner is advantageous, for example, when one of the wheels that is driven by the electric beam axle 10′ is slipping. In this situation, the coupling (i.e., the dog clutch 410 in the example provided) can be operated to rotationally couple the first and second stub shafts 400 and 402, thereby rotationally coupling the driven gears 112 as well as the wheel hubs 172 so that all rotary power (i.e., the rotary power provided by both of the electric motors 90) is essentially applied to the non-slipping drive wheel (when the opposite wheel is slipping).

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An electric beam axle comprising:
a center tube having opposite axial ends, the center tube being disposed coaxially about an output axis; and
a pair of drive units, each of the drive units having a housing assembly, a motor assembly, a wheel hub assembly and a transmission, the housing assembly having a tube mount and defining a cavity, the tube mount defining a tube bore, the center tube being received into the tube bore and being fixedly coupled to the tube mount, the motor assembly having an electric motor with a motor output shaft that is rotatable about a motor axis, the motor assembly being coupled to the housing assembly, the motor output shaft extending into the cavity in the housing assembly, the wheel hub assembly being fixedly coupled to the housing assembly and having a wheel hub that is rotatable about the output axis, the transmission drivingly connecting the motor output shaft to the wheel hub to transmit rotary power between the electric motor and the wheel hub;
wherein the output axis is parallel to but offset from the motor axes.

2. The electric beam axle of claim 1, wherein the housing assembly includes a housing member and an end cap that are joined to one another across a plane that is perpendicular to the output axis, wherein the housing member includes a motor mount flange to which the electric motor is mounted, and wherein the end cap has a bore into which the wheel hub assembly is mounted.

3. The electric beam axle of claim 1, wherein the wheel hub assembly further includes a wheel hub mount and a stub shaft, wherein the wheel hub mount is mounted to the housing assembly, and wherein the stub shaft rotationally couples an output gear of the transmission and the wheel hub.

4. The electric beam axle of claim 3, further comprising a pair of tapered roller bearings, each of the tapered roller bearings being mounted on an associated axial end of the output gear and supporting the output gear for rotation about the output axis relative to the housing assembly.

5. The electric beam axle of claim 3, wherein the wheel hub is supported for rotation about the output axis relative to the wheel hub mount on a pair of tapered roller bearings.

6. The electric beam axle of claim 3, wherein the wheel hub includes a wheel hub flange, wherein the wheel hub assembly further includes an outer hub seal that is disposed along the output axis between the wheel hub flange and the tapered roller bearings.

7. The electric beam axle of claim 3, wherein the wheel hub assembly includes a seal member that is disposed circumferentially between the wheel hub mount and an inside surface of the bore in the end cap.

8. The electric beam axle of claim 3, wherein the stub shaft includes a first externally-splined segment, which is engaged to a first internally-splined segment on the output gear, and a second externally-splined segment that is engaged to a second internally-splined segment on the wheel hub.

9. The electric beam axle of claim 1, wherein the transmission includes an input gear, which is coupled to the motor output shaft for rotation therewith, and a pair of compound gears, each of the compound gears having a first reduction gear that is meshingly engaged to the input gear.

10. The electric beam axle of claim 9, wherein the transmission further includes an output gear, wherein each of the compound gears has a second reduction gear that is coupled for rotation with the first reduction gear, and wherein each of the second reduction gears is meshingly engaged with the output gear.

11. The electric beam axle of claim 1, wherein each of the drive units further includes an inverter, wherein the electric motor has a motor housing, wherein the inverter is electrically coupled to the electric motor and is mounted to the motor housing.

12. The electric beam axle of claim 1, wherein each of the drive units further includes a heat exchanger, wherein the electric motor has a motor housing, and wherein the heat exchanger is fluidly coupled to the electric motor and is mounted to the motor housing.

13. The electric beam axle of claim 1, further comprising a first stub shaft, a second stub shaft and a coupling, wherein the transmission of each of the drive units has an output gear, wherein the first stub shaft is received in the center tube and is coupled for rotation with the output gear of a first one of the drive units, wherein the second stub shaft is coupled for rotation with the output gear of a second one of the drive units and wherein the coupling is selectively operable for rotationally coupling the first and second stub shafts.

14. The electric beam axle of claim 13, wherein the coupling is a clutch.

15. The electric beam axle of claim 14, wherein the clutch is a dog clutch.
